(19) United States
(12) Patent Application Publication
(10) Pub. No.: US 2005/0125230 A1
(43) Pub. Date: Jun. 9, 2005

(54) Method and apparatus for entering alphabetic characters

(76) Inventor: Gregory Haas, Schaumburg, IL (US)

Correspondence Address: Michael G. Fletcher;Fletcher Yoder, P.O. Box 692289, Houston, TX, 77269-2289, US

(21) Appl. No.: 10/731,451

(22) Filed: Dec. 9, 2003

(51) Int. Cl. G10L 11/00

(52) U.S. Cl. 704/270; 704/275; 379/88.01; 367/198; 455/563

(57) ABSTRACT

The disclosed embodiments may relate to a communication device (10). The communication device (10) includes an audio input device (26) that receives voice commands with at least one of the voice commands being an alphabetic character. The communication device (10) also includes memory (30) that is used to store the voice commands. In addition, the communication device (10) includes a control module (12) coupled to the audio input device (26) and the memory (30). The control module (12) associates the at least one of the voice commands with one numeric digit.

### FIELD OF THE INVENTION

The present invention relates generally to a portable communication device, and more particularly, to a voice recognition system that accepts voice commands that include alphabetic characters, numeric digits, and symbolic characters.

### BACKGROUND INFORMATION

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

To exchange information, a user may utilize any one of a variety of communication devices to communicate with another individual at another location. Typical communication devices include telephones, radio telephones, cellular telephones, pagers, two-way radios, and other similar devices. These communication devices are utilized to establish connections with other communication devices for a user.

To operate the various kinds of communication devices, a user may utilize a keypad to enter information, and a display to view information entered through the keypad or generated from the communication device. Typically, the keypad has columns and rows of buttons that include the numbers from “0” to “9,” and symbols, such as “*” and “#.” In addition, the keypad may include the letters “a” through “z,” which may correspond to a specific number. Generally, the numbers, symbols, and letters follow a standard layout with three or four letters being associated with a specific number on the keypad. While the user may utilize the keypad to operate the communication device, in some instances, the use of the keypad may not be convenient. For example, if the user is carrying luggage, the user may not be able to press the buttons on the keypad of the communication device.

In response to this type of problem, some communication devices may include a hands-free mode or voice recognition mode that facilitates operation of the communication device with no use, or minimal use, of the keypad. In this mode, the user may utilize various voice commands to operate the communication device. Each voice command is typically related to a specific function or action to be performed by the communication device. Once the voice command is received, the communication device compares the received voice command with a stored voice command that relates to a specific action. If the received voice command matches a stored voice command, then the communication device may perform the specific action associated with the voice command. Thus, the voice command allows the user to utilize human speech to control the operation of the communication device.

However, for a variety of reasons, the communication device operating in the hands-free mode may not perform the specific command desired by the user. For instance, businesses may market products and services that relate a telephone number to a combination of numeric digits and alphabetic characters, such as 1-800-MOTOROLA. If the user does not remember the relationship of the alphabetic characters to the numeric digits on the keypad of a communication device or is unable to view the keypad of the communication device, the user may be unable to identify the specific phone number, which is 1-800-668-6765 in this example. As such, the user may be unable to dial the specific phone number that relates to the combined alphabetic characters and numeric digits without actually using the keypad.

### BRIEF DESCRIPTION OF THE DRAWINGS

Advantages of the invention may become apparent upon reading the following detailed description and upon reference to the drawings in which:

FIG. 1 is a block diagram of a communication device in accordance with an embodiment of the present invention;

FIG. 2 is a diagram of an exemplary communication system positioned in a vehicle in accordance with an embodiment of the present invention;

FIG. 3 is a diagram of an exemplary communication system in accordance with one embodiment of the present invention; and

FIG. 4 is a flow diagram of an exemplary process in accordance with the present invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present technique is an improved approach for entering alphabetic characters, numeric digits, and symbolic characters into a communication device through the use of voice recognition. Under the present technique, a communication device may receive voice commands, which include alphabetic characters, numeric digits, and/or symbolic characters, for dialing a specific phone number and/or for storing the phone number into memory. Because the communication device may translate the various digits and characters into the specific phone number, a user may utilize the communication device to enter phone numbers that include various types of digits and characters without having to view the keypad. As such, the user may enter numeric digits along with alphabetic characters and symbolic characters to operate the communication device.

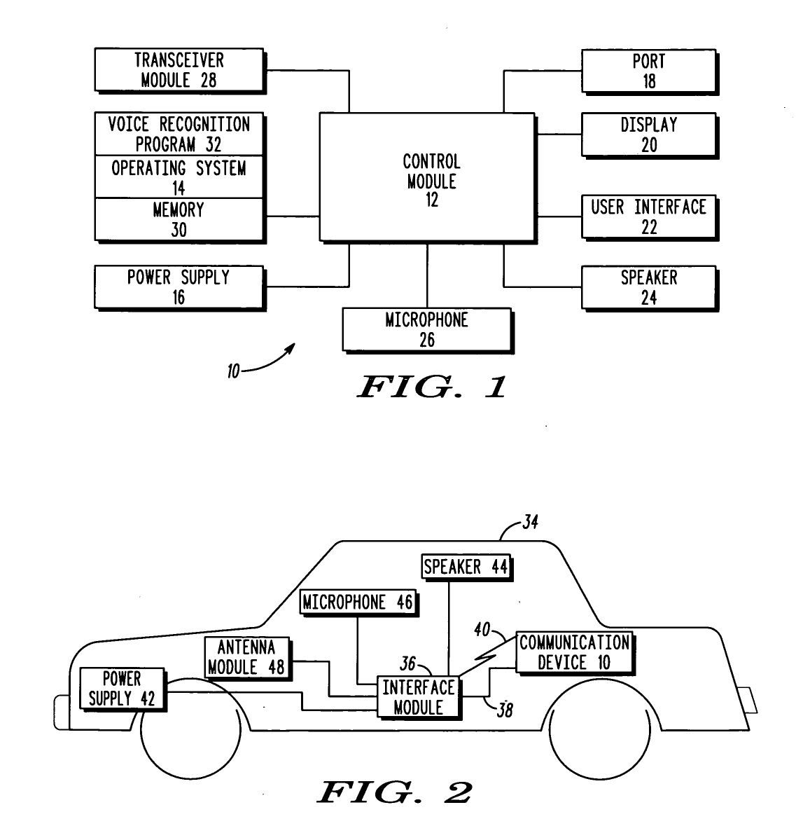

Turning now to the drawings, and referring initially to FIG. 1, an exemplary communication device 10 in accordance with an embodiment with the present invention is illustrated. The communication device 10 may be a cellular telephone that is utilized to communicate with other individuals. Also, it should be note that the communication device 10 may be a cordless telephone, a radiotelephone, a pager, a two-way radio, and/or other similar device. The communication device 10 may include a control module 12, which may be a circuit that includes a processor or group of processors along with other associated circuitry that may be used to provide communication. For instance, the control module 12 may include a processor, which utilizes software programs, such as an operating system 14 and/or voice recognition program 32, which are discussed below. The processor may handle the analog-to-digital and digital-to-analog conversions for signals being exchanged with the communication device 10. Also, the control module 12 may include a voice recognition engine that may be utilized to translate audio signals into sound files that may correspond to specific voice commands.

The control module 12 may utilize an operating system 14 to interact with various hardware components and software programs within the communication device 10. The operating system 14 may manage various operational functions, such as allocating memory, scheduling tasks, accessing memory, displaying information to the user, and polling the interfaces for any entered data. By utilizing the operating system 14, the control module 12 may control the operation of the communication device 10 and may manage the interaction of various modules, such as a power supply 16, a port 18, a display 20, a user interface 22, a speaker 24, a microphone 26, a transceiver module 28, and a memory 30 that may include additional software programs, such as a voice recognition program 32.

The power supply 16 may provide power to the control module 12 and other modules of the communication device 10. The power supply 16 may operate from power that is supplied from batteries or an external source through the port 18, which is discussed below. As an example, the power supply 16 may include rechargeable batteries that may be connected to an electrical distribution system in a vehicle through the port 18.

To interact with the user of the communication device 10, the control module 12 may utilize the display 20 and the user interface 22. The display 20 may be an LCD screen that is used to present the user with information and/graphics, such as numeric digits, symbolic characters, and alphabetic characters. The display 20 may present information that is entered through the user interface 22 and/or provided from the control module 12. The user interface 22 may include keypads or buttons, which are used to enter information into the communication device 10. For instance, the user interface 22 may be a keypad that includes columns and rows of individual keys that are associated with the numeric digits “0” through “9.” Also, each of the keys on the keypad may be associated with a group of alphabetic characters from “a” to “z” along with different symbols, such as “*” or “#.”

Additionally, the speaker 24 and the microphone 26 may be utilized to communicate with the user of the communication device 10 or to communicate with another user of another communication device 10. The speaker 24 may produce audible sounds that are generated based on commands from the control module 12. These audible sounds may relate to the functioning of the control module 12 or to an exchange of data with another communication device 10. The microphone 26 may be used as an audio input device to enter audible sounds into the communication device 10. These sounds may be voice commands for the communication device 10, human speech being used to communicate with another individual, or sounds generated from another machine, such as a fax or modem, for example.

To interact with external devices or systems, the port 18 and the transceiver module 28 may be utilized to establish communication paths with external systems. For instance, the port 18 may be adapted to receive a cable that may be connected to systems external to the communication device 10. These systems may include a vehicle, speakers that are external to the communication device 10, and/or an adapter that interfaces with another system, which are discussed below. The port 18 may use the connection to exchange electrical signals with the control module 12. Similarly, the transceiver module 28 may be connected to the control module 12 to exchange data with the control module 12 or to establish a wireless connection with other devices, as discussed below in greater detail. The data exchanged may include human speech, digital information, control signals, or other audio signals.

To manage the operation of the communication device 10, a memory 30 may be coupled to the control module 12 to store information or software programs, which may be under the control of the control module 12. The memory 30 may include dynamic random access memory, static random access memory, read-only memory, flash memory, or any combination of these memory types. The control module 12 may use the memory 30 to store data for the communication device 10. The stored data may include phone numbers, contact information, sound files, and any other information that might be useful to the user of the communication device 10. Further, the control module 12 may use the memory 30 to store various applications or programs, such as the operating system 14 and the voice recognition program 32.

The voice recognition program 32 may be a software program that is used by the control module 12 to recognize different voice commands. The voice commands may be words or phrases that are stored in the memory 30 in the form of sound files, which are accessible by the communication device 10. When a voice command is received, the communication device 10 may compare the voice command with the stored sound files to determine if a specific function or action should be performed. For instance, the communication device 10 may use the voice commands to store a specific phone number or to dial a phone number.

To operate from voice commands, the control module 12 may utilize the voice recognition program 32 or the control module 12 to translate voice commands into specific actions or instructions. For example, a user of the communication device 10 may be unable to view or access the user interface 22. If the user is listening to a radio or a television program, the user may hear or see a vanity phone number, which is a phone number that includes numeric digits and alphabetic characters. The vanity phone number may be used by businesses or advertisers to market products or services through a unique phone number. If the user is unable to remember or is unable to view the numeric digits associated with the alphabetic characters, then the user is unable to utilize the vanity phone number.

To enhance the operation of the communication device 10, the voice recognition program 32 may be configured to receive voice commands that include alphabetic characters, numeric digits, and symbolic characters that are utilized to represent numeric digits or specific phone numbers. The use of the various digits and characters enables the user to call a phone number that includes a combination of digits and characters, to store a phone number that includes a combination of digits and characters, and/or to interact with other systems that may utilize a combination of digits and characters in a hands free mode. An example of the associations of the voice commands or utterances to the associated numeric digits and symbolic characters are shown in Table 1.

TABLE 1
Voice Command and Associated Numeric Digit

| Utterance or | Associated Numeric Digit or |
|---|---|
| Voice Command | Symbolic Character |
| “one” | “1” |
| “two” | “2” |
| “three” | “3” |
| “four” | “4” |
| “five” | “5” |
| “six” | “6” |
| “seven” | “7” |
| “eight” | “8” |
| “nine” | “9” |
| “zero” | “0” |
| “star” | “*” |
| “pound” | “#” |
| “a,” “b,” “c” | “2” |
| “d,” “e,” “f” | “3” |
| “g” “h,” “i” | “4” |
| “j” “k,” “l” | “5” |
| “m,” “n,” “o” | “6” |
| “p,” “q,” “r,” “s” | “7” |
| “t,” “u,” “v” | “8” |
| “w,” “x,” “y,” “z” | “9” |
| “oh” | “6” |
| “ate” | “8” |

As discussed above, voice commands may be used to correspond to specific numeric digits or actions to be performed by the communication device 10. For instance, the voice command “one” may correspond to the numeric digit “1,” while the voice command “star” may correspond to the symbol “*,” as shown in Table 1. Also, with regard to the alphabetic characters, the voice commands “a,” “b,” and “c” may correspond to the numeric digit “2,” as shown in Table 1. By associating the individual digits and characters to a specific numeric digit, the voice recognition program 32 may translate the various digits and characters into numeric digits that correspond to a specific phone number. This allows the user to utilize voice commands that include numeric digits, symbolic characters, and/or alphabetic characters.

However, it should be understood that the user may also utilize additional utterances and languages with the communication device 10. For instance, certain additional utterances may correspond to specific numeric digits because of similarities in the audible sound (i.e. homophones). Particularly, the utterance “oh” may correspond to the numeric digit “6,” while the utterance “ate” may correspond to the numeric digit “8.” Accordingly, the voice recognition program 32 may relate other words of human speech to specific numeric digits because of the similarity of the utterances with the voice commands. In addition, it should be noted that different languages and dialects may also utilize voice commands with the communication device 10 in a similar manner. For example, the languages may include Spanish, Chinese, French, or any other language or dialect.

To provide other benefits, the communication device 10 may interface with an interface module 36 in a vehicle 34. As shown in FIG. 2, the exemplary vehicle 34 includes an interface module 36 that is used to communicate with the communication device 10. The communication device 10 may be a cellular telephone or other portable communication device that may interact with components within the vehicle 34. The vehicle-based communication system may include the interface module 36, which is connected to a power supply 42, a speaker 44, a microphone 46, and/or an antenna module 48 to enhance the operation of the communication device 10. These components may be individual units, units that are integrated into the vehicle 34, or a standalone unit that combines certain components together. As such, the interface module 36, the power supply 42, the speaker 44, the microphone 46, and/or the antenna module 48 may be utilized by the user of the communication device 10 to enhance the operation of the communication device 10, when it is near the vehicle 34. The interaction of the communication device 10 with the vehicle-based communication system components may be better understood by concurrently viewing FIG. 1.

The interface module 36 may communicate with the communication device 10 through a physical link 38 or a wireless link 40 to facilitate a hands-free mode of operation. With the physical link 38, the interface module 36 may be physically connected to the communication device 10 through the port 18. To provide this physical link 38, the interface module 36 may include a docking station that engages with the communication device 10 or a cable that connects to the communication device 10, for example. The interface module 36 also may secure the communication device 10 within the vehicle 34 to prevent movement of the communication device 10 during the operation of the vehicle 34.

Alternatively, the communication device 10 may communicate with the interface module 36 through the wireless link 40. For instance, the interface module 36 may communicate with the communication device 10 through the transceiver module 28 to establish the wireless link 40. The wireless link 40 may be established between the interface module 36 and the communication device 10 by utilizing Bluetooth™ technology, infrared technology, frequency division multiple access (“FDMA”), time division multiple access (“TDMA”), or and code division multiple access (“CDMA”), for example. Also, the interface module 36 and the communication device 10 may utilize various wireless standards and protocols, such as Bluetooth™ standards, general packet radio system (“GPRS”), global system for mobile communications (“GSM”) or wireless application protocol (“WAP”).

Regardless of the link 38 or 40 being utilized, the interface module 36 may utilize various other components to enhance the operation of the communication device 10. For instance, the interface module 36 may utilize the power supply 42 to provide power to the power supply 16 of the communication device 10. The power supply 42 may receive power generated from the operation of an engine within the vehicle 34. Also, the power supply 42 may include permanent batteries, replaceable batteries, and/or rechargeable batteries that are connected to the electrical distribution system of the vehicle 34.

To interact with the user, the interface module 36 may utilize the speaker 44 and the microphone 46 to provide the interaction between the user and the communication device 10.

For instance, the interface module 36 may use the speaker 44 to produce audio sounds generated from the communication device 10. The speaker 44 may be a group of speakers within the vehicle 34 that are associated with the radio (not shown) or a standalone speaker that is connected to the interface module 36. Similarly, the interface module 36 may use the audio input device or microphone 46 to receive audio signals from the user. The microphone 46 may be located within the vehicle 34 or may be attached to a cable that may be positioned near the user. As such, the speaker 44 and the microphone 46 may enhance or supplement the speaker 24 and microphone 26 of the communication device 10 depending on the specific configuration.

As another enhancement to the communication device 10, the interface module 36 may utilize an antenna module 48 to improve communication with devices that are external to the vehicle 34. The interface module 36 may interface with the radio (not shown) within the vehicle 34 to gain access to the antenna module 48. The antenna module 48 may support open architecture platforms used for universal port combination of real time voice, fax, and data on a network. As such, the antenna module 48 may boost or otherwise modify the signal generated from the communication device 10 to improve the range of the communication device 10 or clarify the signal from the transceiver module 28 of the communication device 10.

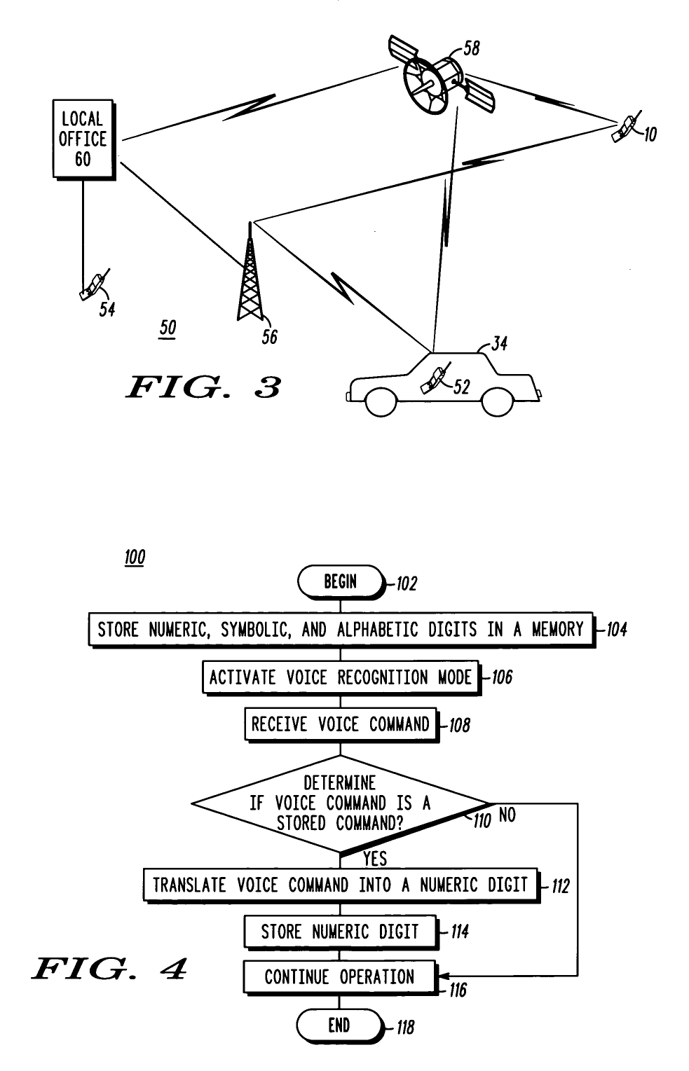

To communicate with other devices, the communication device 10 may interact with a communication system 50, as shown in FIG. 3. In this communication system 50, the communication device 10 may communicate through one or more node stations 56 or one or more satellites 58 to exchange information with a second communication device 52 that is located in a vehicle 34, or a third communication device 54 that is connected to a local office 60.

The node stations 56, the satellites 58, and the local office 60 may be used to provide the communication between communication devices 10, 52, and 54. The node stations 56 may be cellular communication stations, wireless telephone stations, or other similar structures. To exchange signals with the node stations 56, the communication device 10 or 52 may utilize a wireless technology, such as GSM, TDMA, CDMA, FDMA, or other similar technology, as discussed above. The node stations 56 may deliver the audio signals to a local office 60 to communicate with the third communication device 54. The local office 60 may be a central office that has switching equipment to switch calls locally or to long-distance carriers. As an alternative communication route, the communication device 10 may communicate through the satellites 58. The communication between the communication device 10 and the satellites 58 may also utilize wireless or satellite technologies, as discussed above. The satellites 58 may also communicate with the third communication device 54 through the local office 60.

In operating communication devices 10, 52 and 54, the user may enter various digits and characters, such as alphabetic characters, numeric digits, and/or symbolic characters, into the communication device 10 in the form of voice commands. Once a voice command is identified, the communication device 10, 52 and 54 may perform the specific action associated with the voice command. For example, the user of the first communication device 10 may utilize voice commands to enter in a phone number, such as 1-800-MOTOROLA, into the first communication device 10. The first communication device 10 may translate the voice commands into the specific phone number, such as 1-800-668-6765, by using the associations shown in Table 1. Once the various digits and characters are translated, the first communication device 10 may establish a link through the node stations 56 to the local office 60. The local office 60 may establish communication with the third communication device 54, which may be the specified phone number. As such, the user of the first communication device 10 may utilize alphabetic characters, symbolic characters, and numeric digits to establish communication link with another communication device 52 or 54. To further understand the operation of the communication device, a process flow diagram is shown in FIG. 4.

As depicted in FIG. 4, a flow diagram, generally designated by reference numeral 100, is illustrated of a process in accordance with an embodiment of the present invention. The flow diagram 100 may be better understood by concurrently viewing FIGS. 1-3. In the flow diagram 100, the user may utilize the communication device 10 to communicate with another individual. As will be explained below, the communication device 10 may receive voice commands from the user, which may include alphabetic characters, symbolic characters, numeric digits or a combination of the types of digits and characters. Each of these digits and characters may be related to a numeric digit or symbolic character, as shown in Table 1. As a result, the communication device 10 may translate the voice commands into a specific phone number that may be stored in memory or utilized to communicate with another individual.

The process begins at block 102. At block 104, the user of the communication device 10 may store symbolic characters, numeric digits, and/or alphabetic characters into a memory. The digits and characters may correspond to specific numeric digits on the user interface 22, which may be a keypad. The memory may be the memory 30 within the communication device 10 or a memory located within a vehicle 34. At block 106, the hands free or voice recognition mode of the communication device 10 may be activated by the user. The voice recognition mode, which may be used to program voice commands or initiate voice commands, may be continuously active, activated by a specific voice command, or activated by pressing a button or key.

Once the voice recognition mode is activated, the voice command may be received from the user at block 108. The voice command may be received through the microphone 26 or 46, or other suitable audio input device. At block 110, the received voice command may be compared with voice commands that are stored in memory as sound files. If the voice command is determined to be similar to the stored voice command, then the communication device 10 may translate the voice command into an associated numeric digit at block 112. The translation of the received voice command into the specified numeric digit may be handled by the control module 12, which may utilize the voice recognition program 32 or voice recognition hardware. At block 114, the translated numeric digit may be stored in memory. Similarly, the translated numeric digit may also be presented to the user on the display 20. Then, the communication device 10 may continue operation at block 116. The continued operation may include waiting for another voice command or performing the action related to the received voice command. However, if the voice command does not relate to a stored voice command, then the communication device 10 may continue operation at block 116. Accordingly, after block 116, the process ends at block 118.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A communication device, comprising:
an audio input device for receiving a plurality of voice commands, wherein at least one of the plurality of voice commands is associated with an alphabetic character;
a memory for storing the plurality of voice commands; and
a control module coupled to the audio input device and the memory, wherein the control module is configured to associate the at least one of the plurality of voice commands with one of a plurality of numeric digits.

2. The communication device, as set forth in claim 1, comprising a voice recognition program utilized by the control module to translate the at least one of the plurality of voice commands into the one of the plurality of numeric digits.

3. The communication device, as set forth in claim 1, comprising a user interface that is coupled to the control module, wherein the user interface associates the alphabetic character to the one of the plurality of numeric digits.

4. The communication device, as set forth in claim 3, wherein the user interface comprises a keypad.

5. The communication device, as set forth in claim 1, comprising a transceiver module that is coupled to the control module to communicate with another device.

6. The communication device, as set forth in claim 1, comprising a speaker that is coupled to the control module to generate audio.

7. A system, comprising:
a vehicle;
a vehicle-based communication system disposed in the vehicle, the vehicle-based communication system comprising:
an interface module; and
a microphone coupled to the interface module for receiving at least one voice command, wherein the at least one voice command is one of an alphabetic character and
a symbolic character; and
a communication device adapted to communicate with the interface module, the communication device comprising:
a memory for storing the at least one voice command; and
a control complex coupled to the memory, wherein the control complex associates the at least one voice command with one of a plurality of numeric digits.

8. The system, as set forth in claim 7, wherein the communication device and the interface module communicate over a wireless link.

9. The system, as set forth in claim 7, wherein the communication device and the interface module communicate via a physical connection that couples the interface module to a port on the communication device.

10. The system, as set forth in claim 7, comprising an antenna module within the vehicle coupled to the interface module and adapted to be used by the communication device to communicate with an external device.

11. The system, as set forth in claim 7, comprising a speaker coupled to the interface module in the vehicle and adapted for use by the communication device to generate audio.

12. A system, comprising:
a vehicle;
a communication system disposed in the vehicle, the communication system comprising:
an interface module coupled to a microphone for receiving a plurality of verbal commands, wherein at least one of the plurality of verbal commands is one of an
alphabetic character and a symbolic character;
a first communication device in communication with the interface module, the first communication device comprising:
a memory for storing the plurality of verbal commands; and
a control complex coupled to the memory, wherein the control complex associates the at least one of the plurality of verbal commands with one of a plurality of numeric digits; and
a second communication device adapted to communicate with the first communication device via a network.

13. The system, as set forth in claim 12, wherein the network comprises a satellite link between the first communication device and the second communication device.

14. The system, as set forth in claim 12, wherein the network comprises a cellular link between the first communication device and the second communication device.

15. The system, as set forth in claim 12, wherein the first communication device utilizes an antenna module coupled to the interface module, wherein the first communication device provides an audio signal to the antenna module to communicate with the second communication device.

16. The system, as set forth in claim 12, wherein the interface module communicates with the first communication device via a wireless link.

17. A method of operating a communication device, the method comprising the acts of:
entering a voice command into an audio input device;
comparing the voice command to a stored voice command in memory;
translating the voice command into an one of a plurality of numeric digits, if the voice command corresponds to the stored voice command and if the stored voice command corresponds to one of a plurality of alphabetic characters.

18. The method, as set forth in claim 17, comprising storing a voice command in memory, wherein the voice command associates one of the plurality of numeric digits to one of the plurality of alphabetic characters.

19. The method, as set forth in claim 17, wherein the audio input device is a microphone disposed within a vehicle.

20. The method, as set forth in claim 17, wherein the audio input device is a microphone within the communication device.

21. The method, as set forth in claim 17, comprising storing the one of the plurality of numeric digits in memory.

22. The method, as set forth in claim 17, comprising activating the voice recognition mode to receive the voice command.

23. A method of operating a communication device, the method comprising the acts of:
storing a first voice command into a memory;
associating the first voice command to one of a plurality of numeric digits if the first voice command is an alphabetic character;
receiving a second voice command;
comparing the first voice command to the second voice command; and
translating the second voice command into one of the plurality of numeric digits if the first voice command corresponds to the second voice command.

24. The method, as set forth in claim 23, comprising presenting the one of the plurality of numeric digits to a display if the first voice command is similar to the second voice command.

25. The method, as set forth in claim 23, comprising coupling an interface module in a vehicle to the communication device.

26. The method, as set forth in claim 25, wherein receiving the second voice command comprises utilizing a microphone coupled to the interface module and disposed within the vehicle.

27. A method of manufacturing a communication device comprising the acts of:
providing a control module having a processor and a memory for storing a plurality of voice commands;
coupling a microphone to the control module for entering audio;
coupling a display to the control module for presenting information; and
configuring an program within the memory to:
receive audio from the microphone; and
translate the audio into a numeric digit if the audio is similar to a stored voice command, wherein the voice command is one of a plurality of alphabetic characters.

28. The method, as set forth in claim 27, comprises coupling a transceiver module to the control module.

29. The method, as set forth in claim 27, comprises coupling a port to the control module.

30. The method, as set forth in claim 29, comprises configuring the program to communicate with an interface module within a vehicle through the port.

31. The method, as set forth in claim 29, comprises configuring the program to communicate with a microphone external to communication device.
